(19) United States
(12) Patent Application Publication
(10) Pub. No.: US 2016/0148423 A1
(43) Pub. Date: May 26, 2016

(54) ELECTRONIC DEVICE AND METHOD FOR DISPLAYING POLYHEDRONS

(71) Applicant: FIH (HONG KONG) LIMITED, Kowloon (HK)

(72) Inventor: YUNG-SUNG PENG, New Taipei (TW)

(21) Appl. No.: 14/849,858

(22) Filed: Sep. 10, 2015

(30) Foreign Application Priority Data
Nov. 20, 2014 (TW) 103140338

(51) Int. Cl. G06T 17/10; G06F 3/0481; G06F 3/0484; G06F 3/0488

(52) U.S. Cl. CPC G06T 17/10; G06F 3/0488; G06F 3/04817; G06F 3/04847; G06T 2200/24

(57) ABSTRACT

In a method for display polyhedrons on a touch screen of an electronic device, a folder is displayed on the touch screen, the coordinates of the folder and icons included in the folder are obtained. The folder is removed from the touch screen, and a polyhedron is generated in a display location of the folder according to the coordinates of the folder. Each of the icons included in the folder is linked with a side of the polyhedron. The polyhedron generated in the display location of the folder is displayed, and the icons linked with the sides of the polyhedron are displayed on the sides of the polyhedron when the sides are visible with a movement of the polyhedron.

### CROSS-REFERENCE TO RELATED APPLICATIONS

This application claims priority to Taiwanese Patent Application No. 103140338 filed on Nov. 20, 2014, the contents of which are incorporated by reference herein.

### FIELD

The subject matter herein generally relates to user interfaces.

### BACKGROUND

Various applications can be installed in mobile phones, personal digital assistants (PDAs), and other electronic devices, and the applications icons of the applications can be stored in one or more folders which are displayed on a touch screen of the electronic device. However, users need to open a folder to know which icon is stored in the folder.

### BRIEF DESCRIPTION OF THE DRAWINGS

Implementations of the present technology will now be described, by way of example only, with reference to the attached figures.

FIG. 1 is a block diagram of an example embodiment of an electronic device including a polyhedron display system.

FIG. 2 is a block diagram of an example embodiment of function modules of the polyhedron display system in FIG. 1.

FIG. 3 is a diagrammatic view of an example embodiment of a folder.

FIG. 4 is a diagrammatic view of an example embodiment of a polyhedron.

FIG. 5 is a flowchart of an example embodiment of a method for displaying polyhedrons on a touch screen of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

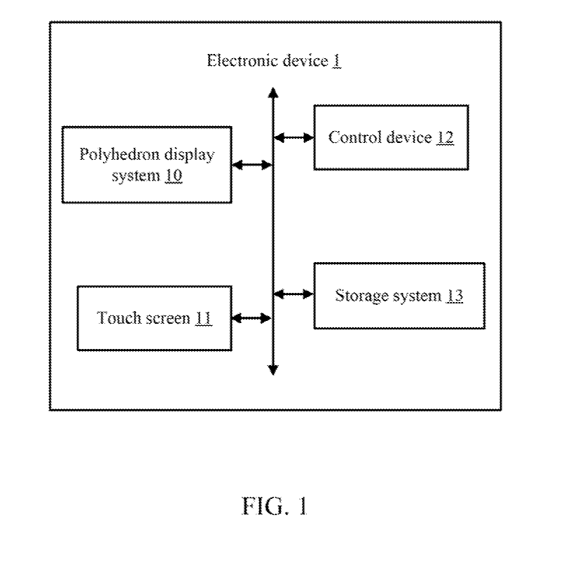

FIG. 1 is a block diagram of an example embodiment of an electronic device 1. In at least one embodiment, a polyhedron display system 10 is installed in and run by the electronic device 1. The electronic device 1 can be a smart phone, a tablet computer, or a personal digital assistant (PDA), and the like. The electronic device 1 can include, but is not limited to, a touch screen 11, at least one control device 12, and a storage system 13. FIG. 1 illustrates only one example of an electronic device that can include more or fewer components than illustrated, or have a different configuration of the various components in other embodiments.

The touch screen 11 can be a liquid crystal display (LCD), an organic light-emitting diode (OLED) display, or the like. The touch screen 11 can recognize touch operations performed on the touch screen 11, for example, a sliding operation, a click operation, a double-click operation, and the like. The at least one control device 12 can be central processing unit (CPU), microcontroller, or digital signal processor. The at least one control device 12 can execute computerized codes of the polyhedron display system 10 and other applications installed in the electronic device 1 to realize the functions of the electronic device 1. The storage system 13 can include various types of non-transitory computer-readable storage media. For example, the storage system 13 can be an internal storage system, such as a flash memory, a random access memory (RAM) for temporary storage of information, and/or a read-only memory (ROM) for permanent storage of information. The storage system 13 can also be an external storage system, such as a hard disk, a storage card, or a data storage medium. In at least one embodiment, when a folder is generated and displayed on the touch screen 13, the coordinates of the folder and a name of the folder can be stored in the storage system 13. Furthermore, if the folder includes a plurality of icons, names of applications represented by the icons can be stored in the storage system 13 in a predetermined order.

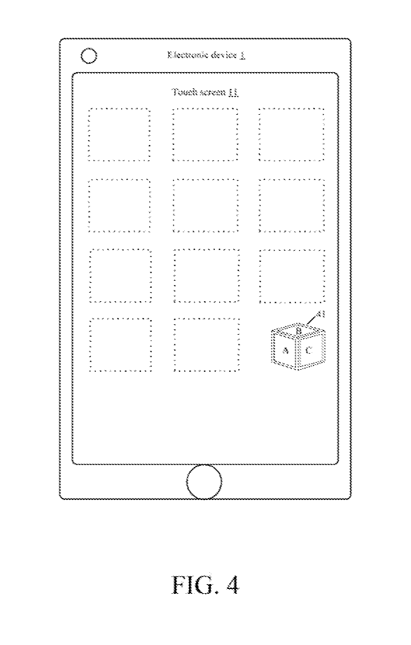

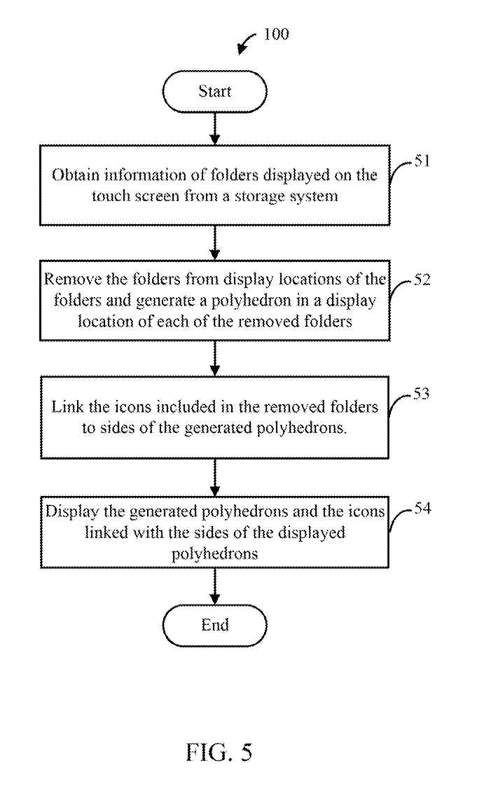

In at least one embodiment, a plurality of folders has been established on the touch screen 11 of the electronic device 1 (see in FIG. 4), and each of the established folders includes at least one icon which corresponds to an application installed in the electronic device 1. When the electronic device 1 runs the polyhedron display system 10, the established folders are removed from the touch screen 11, and a plurality of polyhedrons are generated and displayed in display locations of the removed folders (see in FIG. 5) based on the coordinates of the established folders stored in the storage system 13. Furthermore, In at least one embodiment, if one of the removed folders has included icons, each of the icons can be linked with a side of a polyhedron displayed in a display location of the removed folder, so that the icons can be displayed on the polyhedron when the sides of the polyhedron linked with the icons are visible with a rotation of the polyhedron.

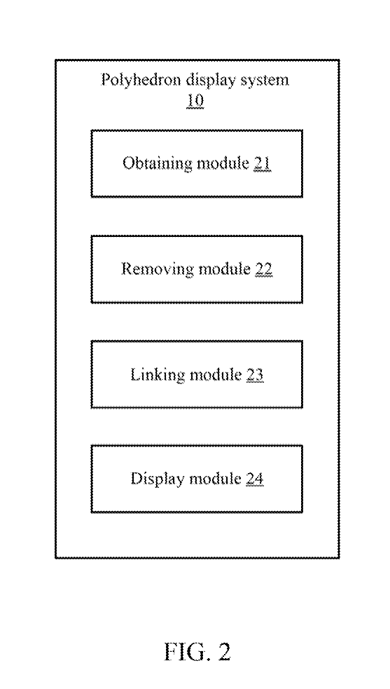

FIG. 2 is a block diagram of an example embodiment of function modules of the polyhedron display system 10. In at least one embodiment, the polyhedron display system 10 can include an obtaining module 21, a removing module 22, a linking module 23, and a display module 24. The function modules 21-24 can include computerized code in the form of one or more programs, which are stored in the storage system 13 and can be executed by the at least one control device 12 to provide functions of the function modules 21-24.

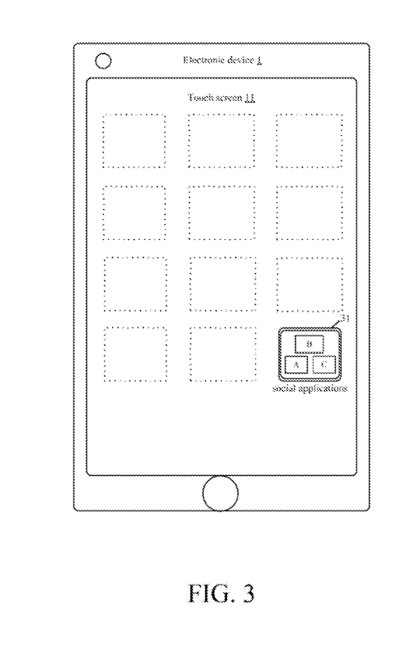

The obtaining module 21 obtains information of folders displayed on the touch screen 11 from the storage system 13, which is stored when the folders are established. In at least one embodiment, the information of the folders includes, but is not limited to, the coordinates of the folders, names of the folder, and icons included in the folders. As shown in FIG. 3, an example folder 31 named “social applications” is displayed in the bottom right corner of the touch screen 11, the folder 31 includes three icons, A icon, B icon, and C icon. The A icon represents an application named A, the B icon represents an application named B, and the C icon represents an application named C.

The removing module 22 removes the folders from the display locations of the folders, and generates a polyhedron in a display location of each of the removed folders. The polyhedron can be a cube, a cuboid, or the like. In at least one embodiment, when a polyhedron is generated in a display location of a removed folder, the polyhedron can be named after the name of the removed folder. For example, as shown in FIG. 4, when the “social applications” folder 31 is removed from the touch screen 11, a cube 41 named “social applications” is generated in a display location of the folder 31.

The linking module 23 links the icons included in the removed folders to the sides of the generated polyhedrons. In at least one embodiment, when a folder is removed from its display location, each icon included in the folder can be linked with a side of the polyhedron, which is generated in the display location of the folder. For example, as shown in FIG. 4-FIG. 5, when the cube 41 is generated in the display location of the folder 31, the A icon included in the folder 31 is linked with a top side of the cube 41, the B icon included in the folder 31 is linked with a left side of the cube 41, and the C icon included in the folder 31 is linked with a right side of the cube 41. In at least one embodiment, when the icons included in the folder are greater that the sides of the polyhedron generated in the display location of the folder, the sides of the generated polyhedron can be partitioned into sections, and each section can be linked with a icon. For example, when the folder includes ten icons and the polyhedron only owns six sides, the six sides of the polyhedron can be partitioned into twelve sections (e.g., each side of the polyhedron is partitioned into two sections), so that the linking module 23 can link the ten icons to ten sections of the partitioned twelve sections.

The display module 24 displays the generated polyhedrons on the touch screen 11, and displays the icons linked with the sides of the displayed polyhedrons on the sides of the displayed polyhedrons when the sides linked with the icons are visible with a movement of the displayed polyhedrons. In at least one embodiment, the displayed polyhedrons are kinetic when a preset touch operation is performed on the displayed polyhedrons. For example, the displayed polyhedrons can be rotated following a sliding operation performed on the displayed polyhedrons. In detail, when the sliding operation is sliding on the displayed polyhedrons from left to right, the displayed polyhedrons can be rotated from left to right. When the sliding operation is sliding on the displayed polyhedrons from right to left, the displayed polyhedrons can be rotated from right to left. When the sliding operation is sliding on the displayed polyhedrons from top to bottom, the displayed polyhedrons can be rotated from back to front. When the sliding operation is sliding on the displayed polyhedrons from the bottom up, the displayed polyhedrons can be rotated from front to back. With the rotation of the displayed polyhedrons, most of the sides of the displayed polyhedrons are visible, the display module 24 displays the icons linked with the visible sides on the visible sides. In at least one embodiment, when a user clicks the displayed icons, the applications represented by the displayed icons can be activated.

In addition, the volumes of the displayed polyhedrons also can be changed when the preset touch operation is performed. For example, when a press operation performed on the displayed polyhedrons, the volumes of the displayed polyhedrons can be increased or decreased according to a time duration of the press. For example, the volumes of the displayed polyhedrons can be increased or decreased by 50% for every five seconds that the press operation is continued. The displayed polyhedrons also can be removed from the touch screen 11, and the removed folders can be reestablished in the display locations of the displayed polyhedrons, when the preset touch operation is performed on the displayed polyhedrons. For example, when a double-click operation is performed on the displayed polyhedrons, the removed folders can be reestablished according to the information of the removed folders stored in the storage system 13.

FIG. 5 illustrates a flowchart of an example embodiment of a method 100 for displaying polyhedrons on a touch screen of an electronic device. In at least one embodiment, the method 100 is provided by way of example, as there are a variety of ways to carry out the method. The method 100 described below can be carried out using the configurations illustrated in FIG. 1-4, for example, and various elements of these figures are referenced in explaining example method. Each block shown in FIG. 5 represents one or more processes, methods, or subroutines, carried out in the exemplary method. Furthermore, the illustrated order of blocks is by example only and the order of the blocks can be changed. The exemplary method can begin at block 51. Depending on the embodiment, additional blocks can be added, others removed, and the ordering of the blocks can be changed.

At block 51, an obtaining module obtains information of folders displayed on the touch screen of the electronic device from a storage system of the electronic device. In at least one embodiment, the information of the folders includes, but is not limited to, the coordinates of the folders, names of the folder, and icons included in the folders.

At block 52, a removing module removes the folders from display locations of the folders, and generates a polyhedron in a display location of each of the removed folders. The polyhedron can be a cube, a cuboid, or the like. In at least one embodiment, when a polyhedron is generated in a display location of a removed folder, the polyhedron can be named after the name of the removed folder.

At block 53, a linking module links the icons included in the removed folders to sides of the generated polyhedrons. In at least one embodiment, when a folder is removed from its display location, each icon included in the folder can be linked with a side of the polyhedron, which is generated in the display location of the folder. If the icons included in the folder are greater that the sides of the polyhedron generated in the display location of the folder, the sides of the generated polyhedron can be partitioned into sections, and each section can be linked with a icon.

At block 54, a display displays the generated polyhedrons on the touch screen, and displays the icons linked with the sides of the displayed polyhedrons on the sides of the displayed polyhedrons when the sides linked with the icons are visible with a movement of the displayed polyhedrons.

In at least one embodiment, the displayed polyhedrons are kinetic when a preset touch operation is performed on the displayed polyhedrons. For example, the displayed polyhedrons can be rotated following a sliding operation performed on the displayed polyhedrons. In detail, when the sliding operation is sliding on the displayed polyhedrons from left to right, the displayed polyhedrons can be rotated from left to right. When the sliding operation is sliding on the displayed polyhedrons from right to left, the displayed polyhedrons can be rotated from right to left. When the sliding operation is sliding on the displayed polyhedrons from top to bottom, the displayed polyhedrons can be rotated from back to front. When the sliding operation is sliding on the displayed polyhedrons from the bottom up, the displayed polyhedrons can be rotated from front to back. With the rotation of the displayed polyhedrons, most of the sides of the displayed polyhedrons are visible, the icons linked with the visible sides can be displayed on the visible sides.

In addition, the volumes of the displayed polyhedrons also can be changed when the preset touch operation is performed. For example, when a press operation performed on the displayed polyhedrons, the volumes of the displayed polyhedrons can be increased or decreased according to a time duration of the press. For example, the volumes of the displayed polyhedrons can be increased or decreased by 50% for every five seconds that the press operation is continued. The displayed polyhedrons also can be removed from the touch screen, and the removed folders can be reestablished in the display locations of the displayed polyhedrons, when the preset touch operation is performed on the displayed polyhedrons. For example, when a double-click operation is performed on the displayed polyhedrons, the removed folders can be reestablished according to the information of the removed folders stored in the storage system.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for displaying polyhedrons on a touch screen of an electronic device, the method comprising:
obtaining information of a folder displayed on the touch screen, the information comprises the coordinates of the folder and icons comprised in the folder;
removing the folder from the touch screen, and generating a polyhedron in a display location of the folder according to the coordinates of the folder;
linking each of the icons comprised in the folder with a side of the polyhedron;
displaying the polyhedron generated in the display location of the folder; and
displaying the icons on sides of the polyhedron which are linked with the icons when the sides linked with the icons are visible with a movement of the polyhedron.

2. The method according to claim 1, wherein the displayed polyhedron is a cube or a cuboid.

3. The method according to claim 1, wherein when a sliding operation is performed on the displayed polyhedron, the displayed polyhedron is rotated following the sliding operation.

4. The method according to claim 3, wherein the sliding operation comprises a sliding operation sliding on the displayed polyhedron from left to right, a sliding operation sliding on the displayed polyhedron from right to left, a sliding operation sliding on the displayed polyhedron from top to bottom, and a sliding operation sliding on the displayed polyhedron from the bottom up.

5. The method according to claim 1, wherein when a press operation performed on the displayed polyhedron, the volumes of the displayed polyhedron is increased or decreased according to a time duration of the press.

6. The method according to claim 1, wherein when a double-click operation is performed on the displayed polyhedron, the displayed polyhedron is removed from the touch screen and the removed folder is reestablished in the display locations of the displayed polyhedron.

7. An electronic device, comprising:
a touch screen;
at least one control device; and
a storage system that stores one or more programs, when executed by the at least one control device, cause the at least one control device to perform operations comprising:
obtaining information of a folder displayed on the touch screen, the information comprises the coordinates of the folder and icons comprised in the folder;
removing the folder from the touch screen, and generating a polyhedron in a display location of the folder according to the coordinates of the folder;
linking each of the icons comprised in the folder with a side of the polyhedron;
displaying the polyhedron generated in the display location of the folder; and
displaying the icons on sides of the polyhedron which are linked with the icons when the sides linked with the icons are visible with a movement of the polyhedron.

8. The electronic device according to claim 7, wherein the displayed polyhedron is a cube or a cuboid.

9. The electronic device according to claim 7, wherein when a sliding operation is performed on the displayed polyhedron, the displayed polyhedron is rotated following the sliding operation.

10. The electronic device according to claim 9, wherein the sliding operation comprises a sliding operation sliding on the displayed polyhedron from left to right, a sliding operation sliding on the displayed polyhedron from right to left, a sliding operation sliding on the displayed polyhedron from top to bottom, and a sliding operation sliding on the displayed polyhedron from the bottom up.

11. The electronic device according to claim 7, wherein when a press operation performed on the displayed polyhedron, the volumes of the displayed polyhedron is increased or decreased according to a time duration of the press.

12. The electronic device according to claim 7, wherein when a double-click operation is performed on the displayed polyhedron, the displayed polyhedron is removed from the touch screen and the removed folder is reestablished in the display locations of the displayed polyhedron.

13. A non-transitory storage medium having stored thereon instructions that, when executed by at least one control device of an electronic device, causes the processor to perform a method for displaying polyhedrons on a touch screen of the electronic device, the method comprising:
obtaining information of a folder displayed on the touch screen, the information comprises the coordinates of the folder and icons comprised in the folder;
removing the folder from the touch screen, and generating a polyhedron in a display location of the folder according to the coordinates of the folder;
linking each of the icons comprised in the folder with a side of the polyhedron;
displaying the polyhedron generated in the display location of the folder; and
displaying the icons on sides of the polyhedron which are linked with the icons when the sides linked with the icons are visible with a movement of the polyhedron.

14. The non-transitory storage medium according to claim 13, the displayed polyhedron is a cube or a cuboid.

15. The non-transitory storage medium according to claim 13, wherein when a sliding operation is performed on the displayed polyhedron, the displayed polyhedron is rotated following the sliding operation.

16. The non-transitory storage medium according to claim 15, wherein the sliding operation comprises a sliding operation sliding on the displayed polyhedron from left to right, a sliding operation sliding on the displayed polyhedron from right to left, a sliding operation sliding on the displayed polyhedron from top to bottom, and a sliding operation sliding on the displayed polyhedron from the bottom up.

17. The non-transitory storage medium according to claim 13, wherein when a press operation performed on the displayed polyhedron, the volumes of the displayed polyhedron is increased or decreased according to a time duration of the press.

18. The non-transitory storage medium according to claim 13, wherein when a double-click operation is performed on the displayed polyhedron, the displayed polyhedron is removed from the touch screen and the removed folder is reestablished in the display locations of the displayed polyhedron.
